(19) United States
(12) Patent Application Publication
(10) Pub. No.: US 2017/0076517 A1
(43) Pub. Date: Mar. 16, 2017

(54) AUTOMATIC DRIVING LOG SYSTEM AND METHOD

(71) Applicant: J. J. Keller & Associates, Inc., Neenah, WI (US)

(72) Inventors: Thomas C. Harter, Neenah, WI (US); Michael K. Kuphal, Greenville, WI (US); Bruce D. Lightner, La Jolla, CA (US)

(21) Appl. No.: 14/851,232

(22) Filed: Sep. 11, 2015

(51) Int. Cl. G07C 5/08; G06Q 10/06

(52) U.S. Cl. CPC G07C 5/0841; G06Q 10/063114

(57) ABSTRACT

Systems and methods for creating driving distance, driving time, and duty time logs for a driver of a commercial motor vehicle (CMV). One method includes defining a geo-fenced region for a work reporting location. The driver and vehicle are monitored to determine the location of the vehicle in comparison to the geo-fenced region, driving time, duty time, and driving distance. These parameters are used to automatically determine and create the correct type of log without user input.

### BACKGROUND

Embodiments of the invention relate to systems and methods for the automatic creation of driving distance, duty time, and driving time logs for drivers of commercial motor vehicles.

Operators of commercial motor vehicles (“CMV's”) are required to meet certain specific performance standards and regulations for operating such vehicles. For example, some operators of the CMV's are required to meet hours-of-service regulations.

The U.S. Department of Transportation requires a driver to create a standard log for a short-haul unless the driver meets exemption criteria. This current exemption criterion are based, in part, on the amount of drive time and duty time a driver has accumulated on each single trip and over a time period which can include numerous trips. A trip is any time a vehicle starts and stops, whether the stop includes on duty time or off-duty time. The exemption criteria also includes the distance the driver has traveled from a normal work reporting location and the starting and ending location of the vehicle for each full trip. A full trip is the combination of all of the trips over a predetermined period of time, such as over a 24 hour period. If a driver meets the criteria, an exemption log is required. Otherwise, a non-exempt log is required. The regulations which define the logging requirements are found at section 395 of the Federal Motor Carrier Safety Administration Regulations 49 Code of Federal Regulations, which is incorporated by reference herein.

### SUMMARY

One embodiment of the invention provides a method of creating driving distance, driving time, and duty time logs for a driver of a commercial motor vehicle. The method includes defining a geo-fenced region for a work reporting location and determining, using a positioning system and the geo-fenced region, a location of the vehicle. In one embodiment, the method also includes a first comparing, using a processor, of a driving time of the driver to a driving time threshold to yield a driving time difference, a second comparing, using a processor, of a duty time of the driver to a duty time threshold to yield a duty time difference; and a third comparing, using a processor, of a driving distance of the vehicle to a distance threshold to yield a driving distance difference. Additionally, the method includes determining which type of log to create based on the location of the vehicle, driving time difference, duty time difference, and driving distance difference and creating the determined log without user input.

Another embodiment of the invention provides a system configured to create a type of driving distance, duty time, or driving time log selected from a plurality of driving logs for a driver of a commercial motor vehicle. The system includes a base unit installed in a vehicle, a controller, at least one processor, and at least one physical computer storage medium. The at least one physical computer storage medium includes stored executable instructions that, when executed by the at least one processor, cause the at least one processor to perform operations to determine the type of log to create. Those operations include defining a geo-fenced region for a work reporting location and determining, using a positioning system and the geo-fenced region, a location of the vehicle. In one embodiment, the operations also include a first comparing of a driving time of the driver to a driving time threshold to yield a driving time difference, a second comparing, using a processor, of a duty time of the driver to a duty time threshold to yield a duty time difference, and a third comparing of a driving distance of the vehicle to a distance threshold to yield a driving distance difference. Additionally, the operations include determining which type of log to create based on the location of the vehicle, driving time difference, duty time difference, and driving distance difference.

In another aspect, an embodiment of the invention includes at least one physical computer storage medium including stored instructions. The stored instructions, when executed, create at least one driving log for a driver of a commercial motor vehicle. The at least one physical storage medium includes instructions which determine, using a positioning system, a location of the vehicle. The instructions also include a first comparing a driving time of the driver to a driving time threshold to yield a driving time difference, a second comparing, using a processor, of a duty time of the driver to a duty time threshold to yield a duty time difference, and a third comparing a driving distance of the vehicle to a distance threshold to yield a driving distance difference. The instructions additionally include determining which type of log to create based on the location of the vehicle, driving time difference, duty time difference and driving distance difference.

In each of the embodiments, distributed processing divides certain tasks between a base unit and a portable device. The base unit defines boundaries and detects when the vehicle crosses those boundaries. The portable device tracks driving time and preferably duty time. Additionally, the portable device generates warnings based on the vehicle's relationship to the boundary and the driving time. Based on the vehicle's relationship to the boundary, driving time, and duty time, the portable device converts an exemption log to a non-exempt log. There are numerous benefits to this distributive processing including a reduced load, increased speed, and a better response time.

Other aspects of the invention will become apparent by consideration of the detailed description and accompanying drawings.

### BRIEF DESCRIPTION OF THE DRAWINGS

FIG. 1 is a schematic illustration of a system structured in accordance with an embodiment of the invention.

FIG. 2 illustrates a base unit of the system in FIG. 1 in a block diagram format.

FIG. 3 shows the comparison of a driving distance of a vehicle to a driving distance threshold to yield a driving distance difference.

FIG. 4 shows the comparison of a driving time of a vehicle to a driving time threshold to yield a driving time difference.

FIG. 5 is a flow diagram to determine whether to create an exempt log or non-exempt log based off of the starting location of a vehicle.

FIG. 6 is a flow diagram showing the determination of the driving distance of a vehicle.

FIG. 7 is a flow diagram depicting the driving time difference computation and duty time difference.

FIG. 8 is a flow diagram depicting the final determination of exemption status.

FIG. 9 shows a sample exempt log according to the present invention.

FIG. 10 shows a sample non-exempt log according to the present invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

In one particular embodiment, the invention provides a system for logging performance of a driver operating a vehicle having a vehicle information system from which at least one vehicle operating parameter may be obtained in a performance monitoring process. The vehicle operating parameters collected through the vehicle information system and information such as operator identity from a portable device are wirelessly communicated to a remote host through a network such as the Internet.

Current regulations include two different time requirement for a 100 air mile distance: Firstly, there is a 12 hour on duty window from when the duty tour starts (at normal work reporting location). The driver must return to the normal work reporting location and be released from duty within 12 hours. Secondly, within the 12 hour duty window, there is a limit of 11 hours for a property carrying driver and 10 hours for a passenger carrying driver in which the driver is allowed to drive.

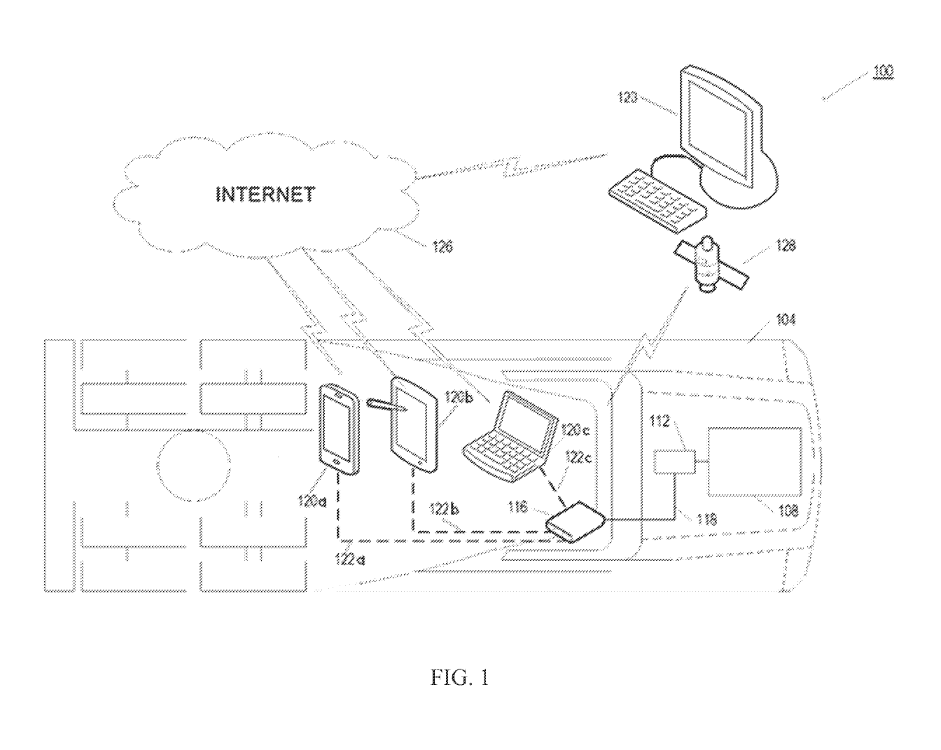

FIG. 1 shows a performance monitoring system 100 for use with a commercial motor vehicle (“CMV”) 104. Although the CMV 104 illustrated is a tractor configured to tow a trailer (not shown), the performance monitoring system 100 can also be implemented in other types of CMV's such as construction vehicles and agricultural equipment. The CMV 104 includes an engine 108 that drives the CMV 104, and is controlled by an electronic control unit (“ECU”) 112 that determines operating information or parameters from the engine 108, and other parts of the CMV 104. Operating parameters monitored by the ECU 112 include speed, hours of service, operating status, ignition switch status, trip distance, total vehicle distance, and the like.

The performance monitoring system 100 also includes an electronic on-board recorder (“EOBR”) base unit 116 that communicates with the ECU 112 through an information bus 118 conforming to standards such as SAE J1939 and SAE J1708 network buses. The base unit 116 has a plurality of functions including, but not limited to, time keeping and data logging. In one implementation, the base unit 116 records and stores CMV information or data from the ECU 112 necessary to comply with U.S. Department of Transportation regulations such as those mentioned above. The performance monitoring system 100 also includes a portable device such as a mobile phone 120a, a tablet 120b, a laptop computer 120c, or the like, that communicates with the base unit 116. The portable device may be an Android, Apple iOS, Microsoft Windows or similar based device. In one embodiment, the portable device includes an application for logging purposes. The application processes and stores data from the base unit 116 retrieved from the information bus 118. The application allows for manual entries made by the driver. The application also generates Hours of Service (HOS) compliance data, vehicle performance data, and driver performance data. This data includes driving time, duty time, and driving distance. The base unit 116 communicates with the portable device through a cable or wireless link 122a, 122b, 122c. The link 122a, 122b, 122c may be a serial cable, such as a USB cable. Other exemplary links include a wireless personal-area-network such as Bluetooth, Wi-Fi, Near Field Communication, and the like. The portable device generally supports multiple platforms such as smart phones 120a, tablets 120b, and computers such as laptops 120c.

The performance monitoring system 100 includes a remote host server 123 running a remote host application that wirelessly communicates with the portable device via a network such as the Internet, detailed hereinafter. An application on the portable device may send data to the remote host server 123 for viewing, reporting, and analyzing. A global position satellite (“GPS”) system or other positioning system 128 also communicates with the ECU 112 and/or the base unit 116 so that information from the GPS system 128 (such as time and location) is available to the CMV 104. In some embodiments, at least a portion of the information stored in the base unit 116 or information communicated to and from the base unit 116 is encrypted.

Distributed processing is shared between the base unit 116 and the portable device. The base unit 116 stores geo-fenced boundaries for the home terminal location, herein referred to as “the work reporting location.” The base unit 116 uses coordinates from the GPS system 128 and determines if those coordinates are within the geo-fenced region. The base unit generates an event which identifies whether a point is within the geo-fenced region. Additionally, the base unit 116 calculates the maximum air mile distance and the driving distance threshold from the geo-fenced region. The base unit 116 creates events which identify when the vehicle crosses the maximum air mile distance and when the vehicle crosses the driving distance threshold.

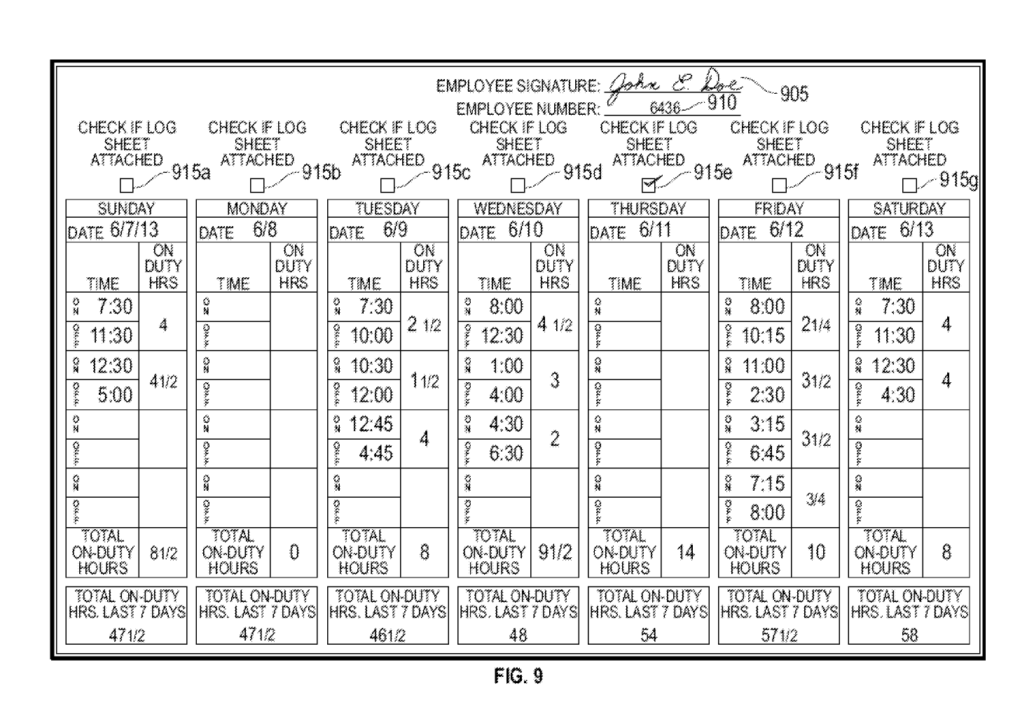

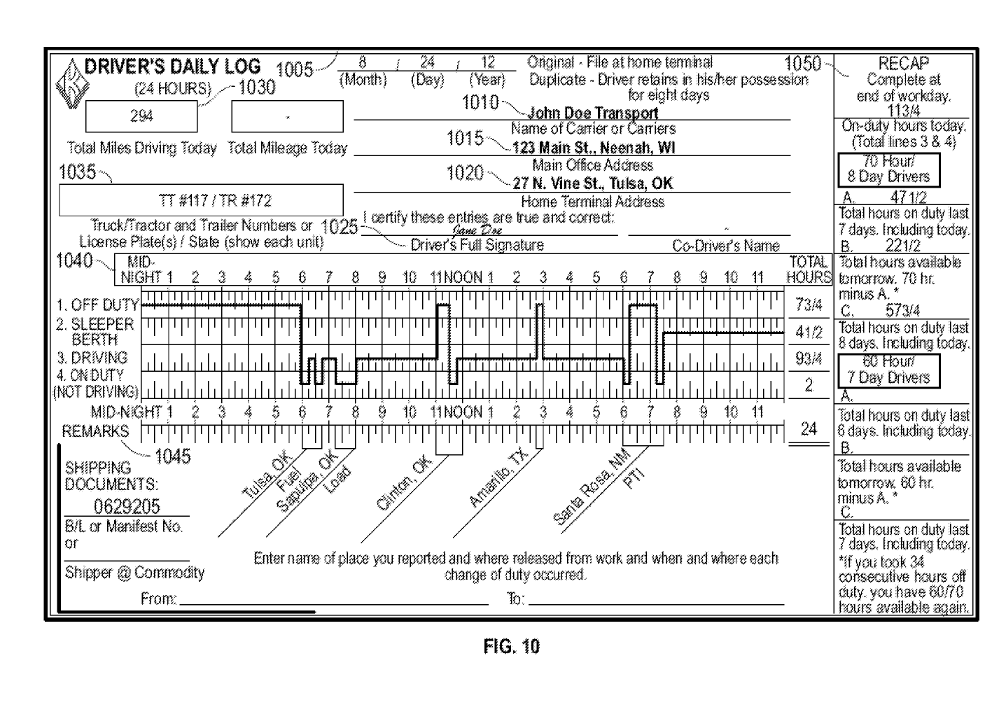

The portable device processes geo-fenced region events to determine if the full trip starts and ends within the geo-fenced region. The portable device also converts the exempt log (FIG. 9) to a non-exempt log (FIG. 10) if the start or end of the full trip is not within the geo-fenced region, if the vehicle crosses the maximum air mile distance, or if the maximum driving time or duty time is exceeded. Additionally, the portable device processes events generated for crossing the maximum air mile distance and the driving distance threshold. The portable device generates a warning to the driver when the vehicle crosses at least 75 percent of the driving distance threshold, and preferably within 95 percent of the driving distance threshold. This warning is maintained as long as the driver is within 75 percent or other preset percentage of the driving distance threshold. Additionally, the portable device tracks the driving time and generates a warning if the driving time is at least 75 percent or other preset percentage of the driving time threshold.

In another embodiment, the portable device computes the geo-fenced calculations including the maximum air mile distance and the driving distance threshold. The portable device performs the calculations to determine if the GPS coordinates are within the geo-fenced region.

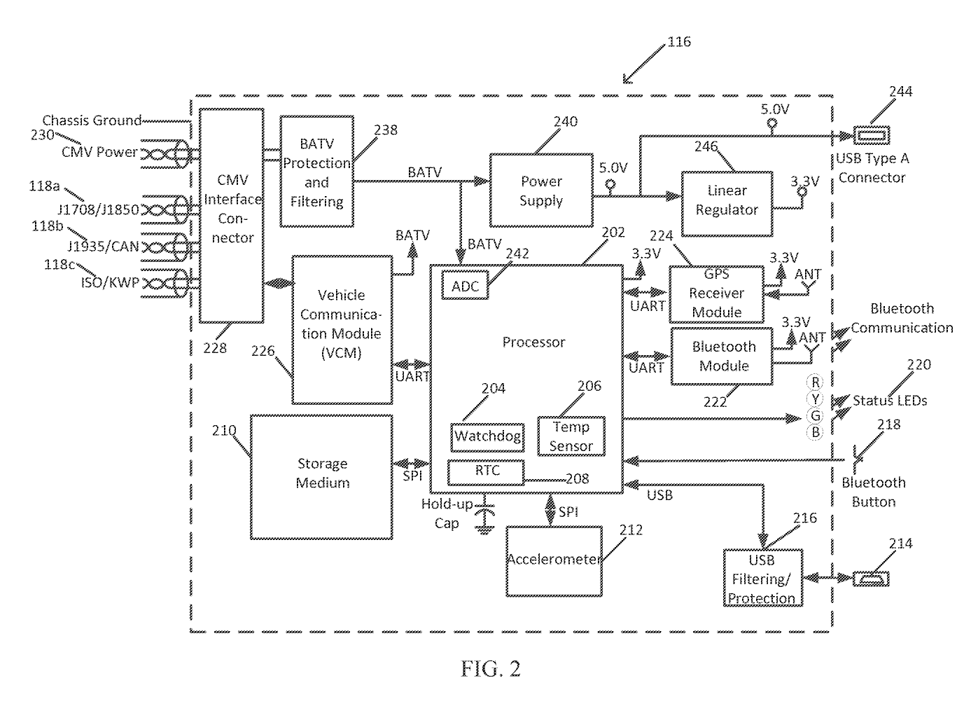

FIG. 2 shows the base unit 116 in a block diagram format. The base unit is a low-power, custom designed telematics device that incorporates a processor 202. In another embodiment, the base unit 116 is a telematics device which gathers vehicle data from the on-board diagnostic (OBD) connecter and includes a GPS receiver.

As shown, the base unit 116 includes a processor (such as a microprocessor, controller or application-specific-integrated-circuit (“ASIC”)) 202. The processor 202 preferably includes a custom programmed STM32ARM Cortex M3 microcontroller with 768 Kbytes of program flash memory and 96 Kbytes of static RAM memory, running FreeRTOS. The processor includes a watchdog 204, temp senor 206, and real-time clock (RTC) 208, which provides a real-time clock function to allow software to accurately determine a time with a predetermined resolution. In some embodiments, the RTC 208 is required to remain operational while the CMV 104 (FIG. 1) does not provide power to the base unit 116.

The processor 202 is coupled to a storage medium 210. The storage medium 210 is physical, non-transient storage device. The storage medium 210 is preferably a non-volatile 32 megabyte flash memory device, but could also be any type of non-volatile flash memory including a NAND or NOR interface or a serial or parallel interface. In addition, the storage medium 210 may be a combination of RAM, ROM, EEPROM, CD-ROM, magnetic disk storage, other magnetic storage devices, or any other medium that could be used to store computer executable instructions or data structures. Both exempt logs (FIG. 9) and non-exempt logs (FIG. 10) are stored in the storage medium 210.

The processor 202 is coupled to an accelerometer 212. The base unit 116 also includes a USB micro AB connector 214 to transmit and receive data through a USB connector of an external portable device. The received data is filtered and protected with a USB protection and filtering module 216 before going to the processor 202. The processor 202 is coupled to a Bluetooth button 218. Additionally, the processor 202 displays the status of the base unit 116 with a plurality of status light-emitting-diodes 220 that are red (R), yellow (Y), blue (B), and green (G).

To communicate with the portable device, the base unit 116 includes a Bluetooth Module 222 configured to be connected to the processor. To receive a GPS signal from the GPS system 128 (FIG. 1), the base unit 116 includes a GPS receiver module configured to be connected to the processor.

The processor 202 is coupled to a vehicle communication module (VCM) 226. The VCM 226 preferably incorporates a custom programmed STM32ARM Cortex M3 microcontroller with 64 Kbytes of programmed flash memory and 20 KB of static RAM memory. This VCM 226 is coupled to a CMV interface connector 228 that connects to the CMV power bus 230. Bus 230 provides communication between the ECU 112 (FIG. 1) and the SAE J1708/SAE J1850 network bus 118a, the SAE J1939/CAN network bus 118b, and the ISO/KWP bus 118b. KWP is a Keyword Protocol promulgated by the International Organization for Standardization.

In the embodiment shown, the base unit 116 receives its power from the CMV 104 through the CMV interface connector 228 and a CMV power bus 230. The power is regulated and surge-protected with a Battery Voltage (BATV) protection and filtering system 238, and a power supply circuit 240 that is preferably a 5.0 V switch mode power supply. This power supply and voltage protection and filtering system 238 are coupled to the processor 202, where the signals are converted with the Analog-to-Digital Converter (ADC) 242. The power supply 240 is also connected to USB type A connector 244 and a linear regulator 246. Preferably, the linear regulator is a 3.3V low-dropout (LDO) linear regulator.

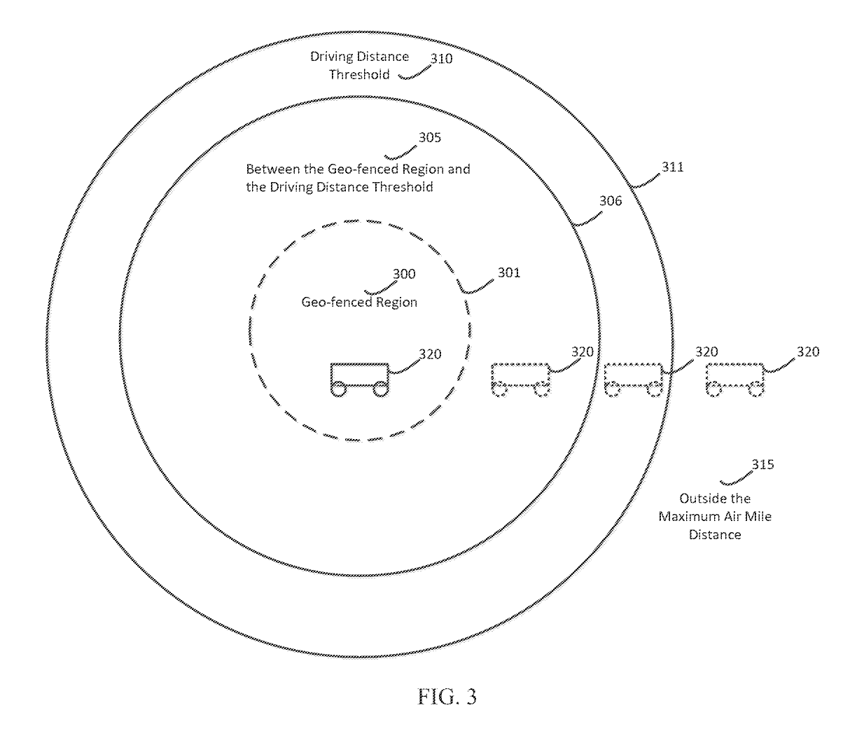

FIG. 3 shows the comparison of a driving distance of a vehicle to a driving distance threshold 310 to yield a driving distance difference. Processing is distributed between the base unit and the portable device to reduce the load, increase speed, and obtain a better response time. Driving distance is the radial distance from the geo-fenced region 300 to the current location of the vehicle. The geo-fenced region is created in a web application using a graphical user interface that displays a map and allows the user to ‘draw’ the geo-fenced region by selecting all of the points of the geo-fenced region to create a polygon shape. The boundaries for the geo-fenced region are stored in the base unit 116 (FIG. 1). In another embodiment, the boundaries are stored on the portable device.

The location of a vehicle is tracked by using the GPS system 128 (FIG. 1) to obtain the vehicle 320 GPS coordinates. These coordinates are compared to the GPS coordinates of a geo-fenced region 300. When the full trip starts, the vehicle 320 needs to be located within the geo-fenced region boundary 301 in order to qualify for an exemption log. An exemption log (FIG. 9) is a log that records only duty times, which is time when the driver is on duty, when a driver stays within a radius of a work reporting location and when the driving time and duty time do not exceed the maximum times as set by the U.S. Department of Transportation. If, at the start of the full trip, the vehicle 320 is not located within the geo-fenced work reporting location 300, but is located in between the geo-fenced region and the driving distance threshold 305, in the driving distance threshold 310, or outside the maximum air mile distance 315, which are all radial distance from the geo-fenced region 320, then a non-exempt log (FIG. 10) is automatically created for the vehicle's full trip. The non-exempt log must include duty statuses tracked for an entire 24 hour period. This log is required, unless exemption criteria are met.

As the vehicle 320 travels, exemption criteria for driving distance are met as long as the vehicle 320 does not travel outside the maximum air mile distance 315. In other words, the vehicle 320 can be located in the geo-fenced region 320, in between the geo-fenced region and the driving distance threshold 305, or in the driving distance threshold 310 to meet exemption criteria for this driving distance as the vehicle travels on its trip. If the vehicle 320 in the driving distance threshold 310 is at least 75 percent of driving distance threshold 310 with 95 percent being preferred, then a warning is generated. The warning is first generated when the vehicle 320 crosses the inner driving distance threshold boundary 306. This warning can be a visual, audio, or another type of notification on a mobile device 120a, tablet 120b, laptop computer 120c, or similar apparatus. This warning may be generated every five minutes, or at another time, that the vehicle 320 is in the driving distance threshold 310. In another embodiment, the warning may be generated every five miles or other distance that the vehicle 320 travels closer to the driving distance threshold outer boundary 311. The vehicle must return to the geo-fenced region 300 at the end of the full trip in order to meet all driving distance criteria for an exempt log (FIG. 9). If the vehicle starts in the geo-fenced region 300, stays within the geo-fenced region 320, in between the geo-fenced region and the driving distance threshold 305 or in the driving distance threshold 310, and returns to the geo-fenced region 300, then all criteria are met for the driving distance portion of creating an exempt log (FIG. 9). To meet the full criteria for an exempt log (FIG. 9), the driving time and duty time need to meet exemption criteria in addition to the driving distance.

If the vehicle is driven outside the maximum air mile distance 315, then the driving distance does not meet exemption criteria, and the driver is notified that the exemption criteria are not met. This notification can be a visual, audio, or another type of notification on a mobile device 120a (FIG. 1), tablet 120b (FIG. 1), computer 120c (FIG. 1), tablet, or similar apparatus. After the notification is given, the system creates a non-exempt log (FIG. 10) for the driver's full trip.

In order to compare the driving distance of a vehicle 320 to a driving distance threshold 310 to yield a driving distance difference, the base unit 116 (FIG. 1) determines when the current vehicle 320 location crosses the outer driving distance threshold boundary 311 or is outside the maximum air mile distance 315 and generates an event. The portable device receives the event and notifies the driver. In another embodiment, the base unit 116 (FIG. 1) continuously calculates the maximum air mile distance between the current vehicle 320 location and the geo-fenced region. When that distance reaches the driving distance threshold 310, an event is generated. The portable device receives the event and notifies the driver by generating a warning.

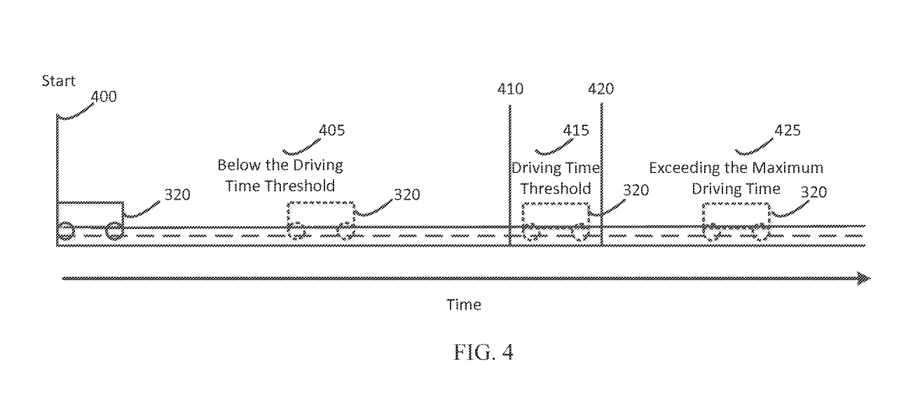

FIG. 4 shows the comparison of a driving time of a vehicle 320 to a driving time threshold 410 to yield a driving time difference. When a full trip begins at location 400, time tracking starts. In order to be meet exemption criteria, the vehicle 320 must start each full trip in the geo-fenced region 300 (FIG. 3). Time may be tracked by using the base unit 116 (FIG. 1) or using the portable device. As time increases in FIG. 4, the vehicle 320 travels to the right. As long as the driving time of vehicle 320 stays in the region that is below the driving time threshold 405 or in the driving threshold region 415, then the full trip meets the driving time exemption criteria for that specific full trip. If the accumulating drive time over a defined period (i.e. total drive time over a 24 hour period), which may include a plurality of full trips, yields a driving time that is below the maximum consecutive drive time, then all the criteria are met for the driving time portion of the exemption criteria.

If the vehicle is driven fora length of time that is at least 75 percent of the driving time threshold 410 (FIG. 4), with 95 percent being preferred, then a warning will be generated. This warning can be a visual, audio, or another type of notification on a mobile device 120a (FIG. 1), tablet 120b (FIG. 1), computer 120c (FIG. 1), or similar apparatus. This warning will be generated when the vehicle 320 crosses the driving time threshold 410 and every five minutes or at another time interval that the vehicle 320 remains in the driving time threshold region 415.

If a vehicle 320 is driven long enough to exceed the maximum driving time 420, then a non-exempt log (FIG. 10) is required to meet compliance standards. Additionally, if the accumulating drive time over a defined period (i.e. total drive time over a 24 hour period), which may include a plurality of full trips, yields a driving time that exceeds the maximum consecutive drive time, then a non-exempt log is required (FIG. 10).

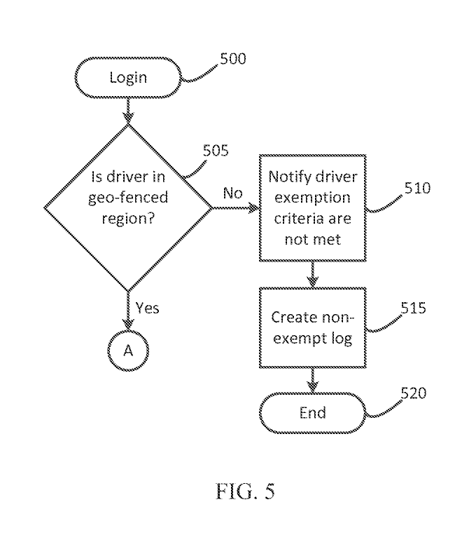

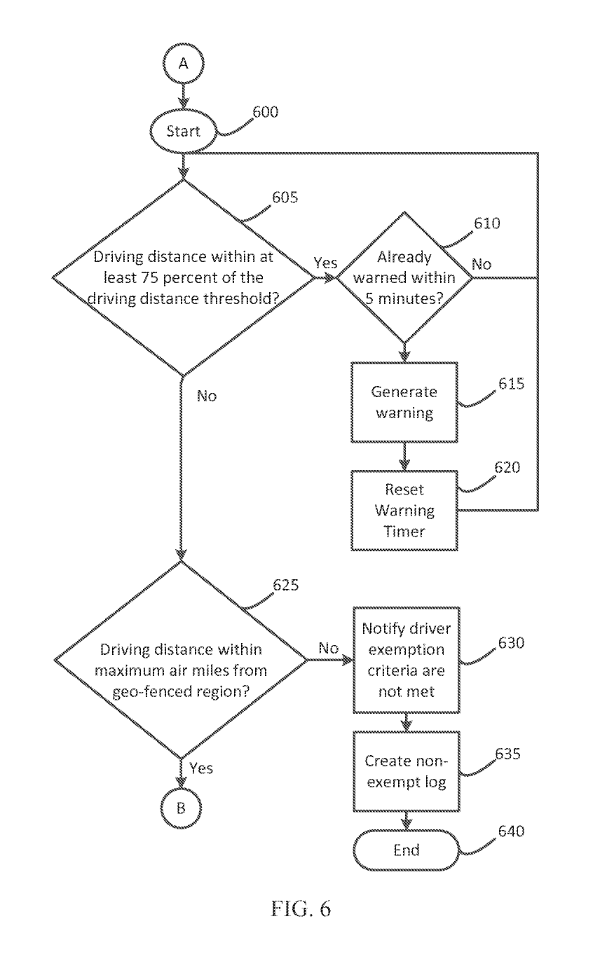

FIG. 5 is a flow diagram to determine whether to create an exempt log (FIG. 9) or non-exempt log (FIG. 10) based off of the starting location of the vehicle 320. Processing is distributed between the base unit and the portable device to reduce the load, increase speed, and obtain a better response time. The computer instructions which, when executed, implement the described steps are stored on a physical non-transient storage device 210 (FIG. 2). The process starts with the driver logging in at step 500 using an interface on a mobile device 120a (FIG. 1), tablet 120b (FIG. 1), computer 120c (FIG. 1) or similar apparatus. The driver is associated with this apparatus using a well-known authentication protocol. Once the driver logs in, the location of the vehicle is determined at step 505 by comparing the GPS coordinates given for the vehicle by the GPS system 128 (FIG. 1) to the GPS coordinates of the geo-fenced region 300 (FIG. 3). If the vehicle starts within the geo-fenced region 300 (FIG. 3), then the starting work reporting location is compliant with exemption criteria and the process to determine which type of log to create moves on to step 605 (FIG. 6). If the vehicle does not start within the geo-fenced region 300 (FIG. 3), then the starting location does not meet exemption criteria, and the driver is notified that the exemption criteria are not met at step 510. This notification can be a visual, audio, or another type of notification on a mobile device 120a (FIG. 1), tablet 120b (FIG. 1), computer 120c (FIG. 1), or similar apparatus. After the notification is given, the system automatically creates a non-exempt log (FIG. 10) for the driver's full trip 515, and the routine ends at step 520.

FIG. 6 is a flow diagram showing the determination of the driving distance of a vehicle. Processing is distributed between the base unit and the portable device to reduce the load, increase speed, and obtain a better response time. The computer instructions which, when executed, implement the described steps are stored on a physical non-transient storage device 210 (FIG. 2). If the starting location was compliant with exemption criteria as decided in FIG. 5, then the process starts at step 600. The system monitors the driving distance of a vehicle and compares it to a driving distance threshold 310 (FIG. 3). The driving distance is the radial distance from the geo-fenced 300 (FIG. 3) region to the current location of the vehicle 320 (FIG. 3). If the driving distance is at least 75 (preferably 95) percent of the driving distance threshold 605, the system checks to see if there has been a warning within five minutes, or at another time, that the vehicle 320 (FIG. 3) is in the driving distance threshold 31 Oat step 610. In another embodiment, the warning may be generated every five miles or other distance that the vehicle 320 (FIG. 3) is driven closer to the driving distance threshold outer boundary 311 (FIG. 3) If there has been a warning, then the system continues to check if the vehicle is within at least 75 (preferably 95) percent of the driving distance threshold at step 605. If there has not been a warning, then a warning is generated at step 615. This warning may be a visual, audio, or another type of notification on a mobile device 120a (FIG. 1), tablet 120b (FIG. 1), computer 120c (FIG. 1), or similar apparatus. After the warning is generated, the warning timer is reset at step 620, and the system continues to check at step 605 whether the driving distance is within at least 75 percent of the driving distance threshold 310 (FIG. 3).

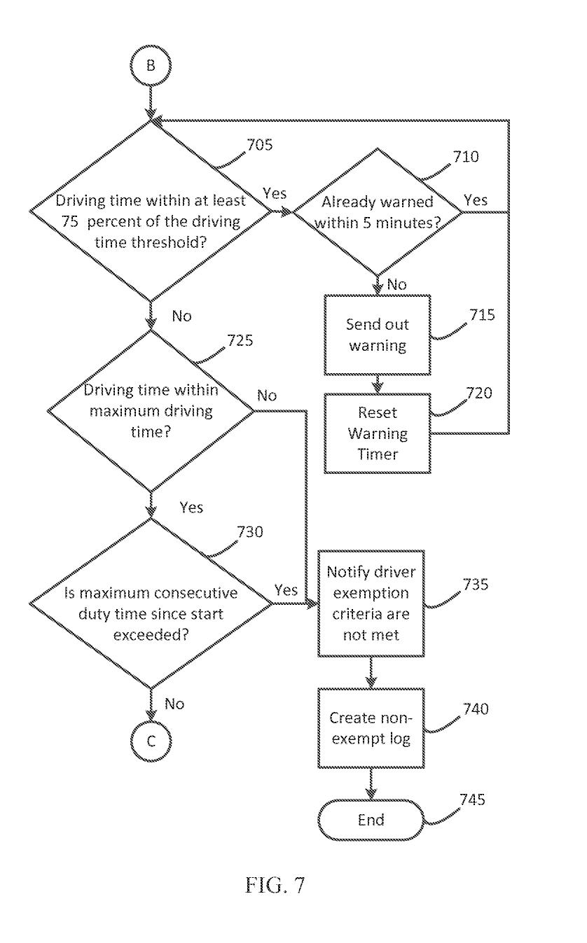

If the driving distance is not within at least 75 percent of the driving distance threshold, then the system determines if the vehicle is outside the maximum air miles distance 315 (FIG. 3) at step 625. The maximum air miles is a radial distance from the geo-fenced region 320 (FIG. 3). If the vehicle is within the maximum air mile distance from the geo-fenced region, then exemption criteria are met for the driving distance of the full trip and the system continues to step 705 (FIG. 7). If the vehicle is outside the maximum air mile distance 315 (FIG. 3), then the driving distance does not meet the exemption criteria, and the driver is notified that the exemption criteria are not met at step 630. This notification may be a visual, audio, or another type of notification on a mobile device 120a (FIG. 1), tablet 120b (FIG. 1), computer 120c (FIG. 1), or similar apparatus. After the notification is given, the system automatically creates a non-exempt log (FIG. 10) for the driver's full trip 635, and the routine ends at step 640.

FIG. 7 is a flow diagram depicting the driving time difference computation and duty time difference. Processing is distributed between the base unit and the portable device to reduce the load, increase speed, and obtain a better response time. The computer instructions which, when executed, implement the described steps are stored on a physical non-transient storage device 210 (FIG. 2). If the driving distance was compliant with exemption criteria as determined in FIG. 6, then the process to determine the driving time difference starts at step 705. The system monitors the driving time with the base unit 116 (FIG. 1) or the portable device and checks if the driving time is within at least 75 (preferably 95) percent of the driving time threshold 410 (FIG. 4). The driving time threshold is preferably a preset value. If the driving time is at least 75 percent of the driving time threshold 410 (FIG. 4) as determined at step 705, the system checks at step 710 to see if there has been a warning within the previous five minutes. If there has been such a warning, then the system loops back to step 705 and continues to check if the vehicle is within at least 75 percent of the driving time threshold 410 (FIG. 4). If there has not been a warning, then a warning is generated at step 715 when the vehicle reaches the 75 percent warning value. This warning may be a visual, audio, or another type of notification on a mobile device 120a (FIG. 1), tablet 120b (FIG. 1), computer 120c (FIG. 1), or similar apparatus. After the warning is generated, the warning timer is reset at step 720, and the system continues to check if the driving distance is within at least 75 percent of the driving time threshold 410 (FIG. 4) at step 705.

If the driving time is not within at least 75 percent of the driving time threshold 410 (FIG. 4), with 95 percent being preferred, then the system checks at step 725 if the vehicle is within the maximum driving time for this specific full trip. The maximum driving time is a preset time as defined in the regulations. If the vehicle has traveled less than the maximum driving time on this full trip, then the exemption criteria are met for the driving time parameter of the full trip, and the system checks at step 730 if the maximum consecutive duty time since the start of a counting period has been exceeded.

If driving time has exceeded maximum driving time 415 (FIG. 4), then the driving time does not meet exemption criteria, and the driver is notified at step 735 that the exemption criteria are not met. This notification may be a visual, audio, or another type of notification on a mobile device 120a (FIG. 1), tablet 120b (FIG. 1), computer 120c (FIG. 1), or similar apparatus. After the notification is given, the system automatically creates a non-exempt log (FIG. 10) for the driver's full trip at step 740, and the routine ends at step 745.

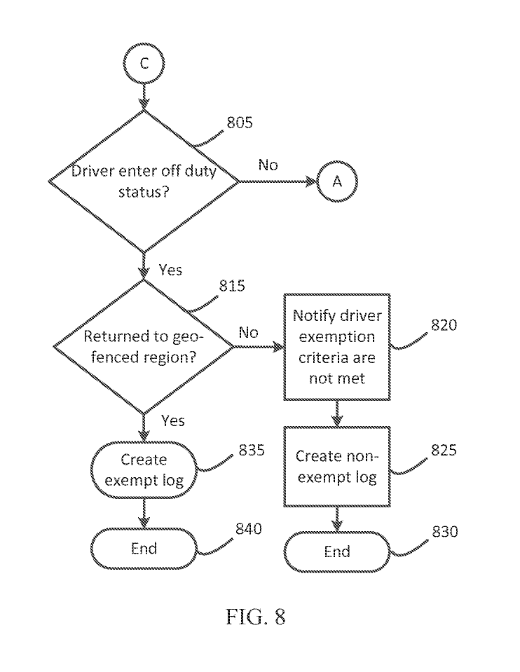

If the comparison at step 725 indicates that the driving time does not exceed the maximum driving time, the system performs a comparison at step 730 to determine if the consecutive duty time has exceeded the maximum consecutive duty time. The maximum consecutive time is a consecutive time over a defined period of time that may be a single full trip, or may be an accumulation of several trips' times. If the consecutive duty time exceeds the maximum consecutive duty time allowed, then the duty time does not meet the exemption criteria, and the driver is notified that the exemption criteria are not met 735. This notification can be a visual, audio, or another type of notification on a mobile device 120a (FIG. 1), tablet 120b (FIG. 1), computer 120c (FIG. 1), or similar apparatus. After the notification is given, the system automatically creates a non-exempt log (FIG. 10) for the driver's full trip at step 740, and the routine ends at step 745. If the consecutive duty time is within the allowable maximum consecutive time, then the exemption criteria have been met for this portion of the full trip and the system continues to step 805 in FIG. 8.

FIG. 8 is a flow diagram depicting the final determination of exemption status. The computer instructions which, when executed, implement the described steps are stored on a physical non-transient storage device 210 (FIG. 2). At step 805, the system checks to see if an off duty status has been set. The off duty status indicates the end of a trip. This status can be set using an interface on a mobile device 120a (FIG. 1), tablet 120b (FIG. 1), computer 120c (FIG. 1), or similar apparatus. If the off duty status is not entered, the system proceeds to step 810 and continues to monitor the vehicle time and location to determine which type of log to create. If the duty status is set to off duty, then the system determines at step 815 if the vehicle returned to the geo-fenced region 320 (FIG. 3), which coincides with the work reporting location. This is done by checking the GPS coordinates of the vehicle and comparing the actual vehicle coordinates with the GPS coordinates of the geo-fence region 300 (FIG. 1) at step 815. If the vehicle did not return to the geo-fenced region 300 (FIG. 3), then the driver is notified at step 820 that the exemption criteria are not met. This notification can be a visual, audio, or another type of notification on a mobile device 120a (FIG. 1), tablet 120b (FIG. 1), computer 120c (FIG. 1), or similar apparatus. After the notification is given, the system automatically creates a non-exempt log (FIG. 10) for the driver's full trip at step 825, and the routine ends at step 830.

If the vehicle returned to the geo-fenced region, then all of the exemption criteria were met and an exempt log (FIG. 9) is automatically created at step 835, and the routine ends at step 840.

FIG. 9 shows a sample exempt log according to the present invention. An exempt log only tracks time. The log includes a driver signature 905 and an employee number 910. The log automatically obtains the driver signature 905 and employee number 910 from the log in process on the portable device. The log includes a column for each day of the week 915a-915g. These columns include the on duty start time and end time for each trip along with the total on duty driving time for each day. Additionally, the columns include the total on duty driving time over a week.

FIG. 10 shows a sample non-exempt log according to the present invention. A non-exempt log tracks duty statuses for an entire 24 hour period. The log includes a date 1005, name 1010, main office address 1015, home terminal address 1020, and driver's signature 1025. All of this information is associated with the driver when the driver logs in to a portable device. The total miles are recorded on the log 1030 along with information including a vehicle number, a license plate, and/or a state. The center of the log includes the hour tracking grid 1040. This grid displays the duty status of the driver for a consecutive 24 hour period of each day. Under the hour tracking grid 1040 are the remarks 1045 where a driver's inputted notes are added. The right-hand column is a summary or recap 1050 of the full trip and amount of drive time over a period of time.

Various features and aspects of embodiments of the invention are set forth in the following claims.

What is claimed is:

1. A method of creating driving logs for a driver of a commercial motor vehicle, the method comprising:
defining a geo-fenced region for a work reporting location;
determining, by a positioning system and the geo-fenced region, a location of the vehicle;
a first comparing, using a processor, of a driving time of the driver to a driving time threshold to yield a driving time difference;
a second comparing, using a processor, of a driving distance of the vehicle to a distance threshold to yield a driving distance difference;
determining whether to create either an exemption log or a non-exempt log based on the location of the vehicle, driving time difference, and driving distance difference; and
creating the determined log without input from the driver.

2. The method of claim 1, further comprising:
a third comparing, using a processor, of a duty time of the driver to a duty time threshold to yield a duty time difference.

3. The method of claim 1, further comprising:
generating a warning when the driving time is at least 75 percent of the driving time threshold.

4. The method of claim 1, further comprising:
accumulating time over at least one of a single instance and a plurality of instances to yield the driving time.

5. The method of claim 1, further comprising:
generating a warning when the driving distance is at least 75 percent of the driving distance threshold.

6. The method of claim 1, further comprising:
generating a warning when the driving time is at least 75 percent of the driving time threshold; and
generating a warning when the driving distance is at least 75 percent of the driving distance threshold.

7. The method of claim 1, further comprising monitoring at least one of the driving time difference, a duty time difference, and the driving distance difference in real time.

8. The method of claim 1, further comprising detecting, using the base unit, when the vehicle crosses at least one of a geo-fenced boundary and a distance threshold boundary.

9. The method of claim 1, further comprising tracking the driving time using a portable device.

10. The method of claim 1, further comprising generating a warning, using a portable device, based on the driving time and the vehicle relationship to at least one of a geo-fenced boundary and a distance threshold boundary.

11. The method of claim 1, further comprising converting, using a portable device, either an exemption log to a non-exempt log based on the driving time and the vehicle relationship to at least one of a geo-fenced boundary and a distance threshold boundary.

12. A system configured to create a type of driving log selected from a plurality of driving logs for a driver of a commercial motor vehicle, the system comprising:
a base unit installed in a vehicle;
at least one processor;
at least one physical computer storage medium comprising stored executable instructions that when executed by the at least one processor cause the at least one processor to perform the following operations to determine the type of log to create defining a geo-fenced region for a work reporting location;
determining, by a positioning system and the geo-fenced region, a location of the vehicle;
a first comparing of a driving time of the driver to a driving time threshold to yield a driving time difference;
a second comparing, using a processor, of a driving distance of the vehicle to a distance threshold to yield a driving distance difference; and
determining whether to create either an exemption log or a non-exempt log based on the location of the vehicle, the driving time difference, and the driving distance difference.

13. The system of claim 12, wherein the at least one physical computer storage medium includes instructions that when executed include a third comparing, using a processor, of a duty time of the driver to a duty time threshold to yield a duty time difference.

14. The system of claim 12, wherein the at least one physical computer storage medium includes instructions that when executed define a geo-fenced region.

15. The system of claim 12, wherein the at least one physical computer storage medium includes instructions that, when executed compare a location of the vehicle to a geo-fenced region.

16. The system of claim 12, wherein the at least one physical computer storage medium includes instructions that when executed generate a warning when the driving time is at least 75 percent of the driving time threshold.

17. The system of claim 12, wherein the at least one physical computer storage medium includes instructions that when executed generate a warning when the driving distance is at least 75 percent of the driving distance threshold.

18. The system of claim 12, wherein the at least one physical computer storage medium includes instructions that when executed:
generate a warning when the driving time is at least 75 percent of the driving time threshold; and
generate a warning when the driving distance is at least 75 percent of the driving distance threshold.

19. The system of claim 12, wherein the at least one physical computer storage medium includes instructions that when executed compare the driving time and the driving distance in real time.

20. The system of claim 12, wherein the at least one physical computer storage medium includes instructions that when executed detect, using the base unit, when the vehicle crosses at least one of a geo-fenced boundary and a threshold boundary.

21. The system of claim 12, wherein the at least one physical computer storage medium includes instructions that when executed track driving time using a portable device.

22. The system of claim 12, wherein the at least one physical computer storage medium includes instructions that when executed generate a warning, using a portable device, based on the driving time and the vehicle relationship to at least one of a geo-fenced boundary and a distance threshold boundary.

23. The system of claim 12, wherein the at least one physical computer storage medium includes instructions that when executed convert, using a portable device, the exemption log to the non-exempt log based on the driving time and the vehicle relationship to at least one of a geo-fenced boundary and a distance threshold boundary.

24. At least one physical computer storage medium comprising stored instructions which when executed create at least one driving log for a driver of a commercial motor vehicle, the at least one physical storage medium comprising executable instructions which perform the following operations:
determining, using a positioning system, a location of the vehicle;
first comparing a driving time of the driver to a driving time threshold to yield a driving time difference;
second comparing a driving distance of the vehicle to a distance threshold to yield a driving distance difference; and
determining whether to create an either an exemption log or a non-exempt log based on the location of the vehicle, the driving time difference, and the driving distance difference.

25. The storage medium of claim 24, wherein the at least one physical computer storage medium includes instructions that when executed include a third comparing, using a processor, of a duty time of the driver to a duty time threshold to yield a duty time difference.

26. The storage medium of claim 24, wherein the at least one physical computer storage medium includes instructions that when executed define a geo-fenced region.

27. The storage medium of claim 24, wherein the at least one physical computer storage medium includes instructions that when executed generate a warning when the driving time is at least 75 percent of the driving time threshold.

28. The storage medium of claim 24, wherein the at least one physical computer storage medium includes instructions that when executed generate a warning when the driving distance is at least 75 percent of the driving distance threshold.

29. The storage medium of claim 24, wherein the at least one physical computer storage medium includes:
instructions that when executed generate a warning when the driving time is at least 75 percent of the driving time threshold; and
instructions that when executed generate a warning when the driving distance is at least 75 percent of the driving distance threshold.

30. The system of claim 24, wherein the at least one physical computer storage medium includes instructions that when executed compare the driving time and the driving distance in real time.

31. The storage medium of claim 24, wherein the at least one physical computer storage medium includes instructions that when executed detect, using the base unit, when the vehicle crosses at least one of a geo-fenced boundary and a threshold boundary.

32. The storage medium of claim 24, wherein the at least one physical computer storage medium includes instructions that when executed track driving time using a portable device.

33. The storage medium of claim 24, wherein the at least one physical computer storage medium includes instructions that when executed generate a warning, using a portable device, based on the driving time and the vehicle relationship to at least one of a geo-fenced boundary and a distance threshold boundary.

34. The storage medium of claim 24, wherein the at least one physical computer storage medium includes instructions that when executed convert, using a portable device, an exemption log to a non-exempt log based on the driving time and the vehicle relationship to at least one of a geo-fenced boundary and a distance threshold boundary.
